(19) United States
(12) Patent Application Publication
(10) Pub. No.: US 2002/0007283 A1
(43) Pub. Date: Jan. 17, 2002

(54) Employee dispute resolution via a network

(76) Inventor: Albert M. Anelli, Garden Grove, CA (US)

Correspondence Address: Albert M. Anelli, 13282 Havenwood Dr., Garden Grove, CA, 92843, US

(21) Appl. No.: 09/903,972

(22) Filed: Jul. 11, 2001

Related U.S. Application Data
(60) Provisional application No. 60/217,274, filed on Jul. 11, 2000.

(51) Int. Cl. G06F 17/60

(52) U.S. Cl. 705/1

(57) ABSTRACT

A unique method for resolving employee disputes via a network is disclosed, the method comprising: typing a grievance in a computer readable form; communicating the grievance to a first lower level of representation in a union if one exists; communicating an approved grievance to a first lower level of management in a defending company; communicating the grievance to a human resources organization within the company; communicating responses to said grievances back to the grievant and any representing organization; when the grievance is not resolved by the lower levels of management, repeatedly communicating the grievance to a higher level of management within the organizations until the grievance is resolved; and when the grievance is not resolved within the organizations, communicating the grievance to an outside party or to an approved peer body for resolution. Substantially all communications are performed via a private computer network, the public Internet, or via wireless networks. The method substantially replaces the paper-based method of resolving disputes in complex organizations that may have union representation. The method grants administration rights to all party domains for privacy and data protection. The method includes time guideline management, remedy implementation management, database storage and retrieval and decision support, management reporting features, and group dispute resolution capabilities.

### CROSS-REFERENCE TO RELATED APPLICATIONS

This application is entitled to the benefit of Provisional Patent Application Ser. No. 60/217,274, filed Jul. 11, 2000 entitled “DISPUTE RESOLUTION VIA THE INTERNET” and bearing attorney docket number 39327/NEC/1420, the disclosures of which are incorporated herein, in their entirely, by reference.

### BACKGROUND

1. Field of Invention

The present invention relates generally to dispute resolution and more specifically relates to a method for providing complete employee dispute resolution operation and management via a network.

2. Discussion of Prior Art

Disputes arise when two or more parties interact or do business and one senses an injustice or feels wronged by the other. Resolving the disputes is often a time consuming process that consumes resources of both time and money. Naturally then, resolving disputes in an effective and efficient manner is a goal of many in the field.

The union and non-union employee grievance process is one excellent example of the improvement and applicability of my invention over the prior art. Grievance procedures are a high priority bargaining issue for unions because they allow employees to object to unilateral management action during the term on an agreement. Often, Companies use a parallel dispute resolution process for non-union employees because they sometimes desire to handle employees' complaints similarly to avoid liability. But high grievance rates are associated with decreased productivity. While low morale might be a cause, productivity decreases also occur because employees and supervisors are involved in settling grievances rather than in production during working hours. The current methods use manual paper based processes, which are tedious and time consuming and are stored in inconvenient locations and are sometimes lost. There is a need then for online employee dispute resolution processes, which shorten the cycle time of a grievance and decrease its cost to manage. Companies and Unions also need a grievance management system that provides strategic information for setting policies and negotiating changes to work systems, terms, and conditions.

The age of computerization has brought several attempts to solve general dispute resolution via electronic and networked means, but they do not work for employee dispute resolution in most cases.

U.S. Pat. No. 5,495,412 of Feb. 27, 1996 introduced an automated dispute resolution mechanism that attempts to optimize the settlement between both parties. This method is not helpful when one party incorrectly interprets a contract and is not legally entitled to anything. When resolving employee disputes, it is important that management retain control over the remedy internally because of the risk of setting a precedent with negative business impact.

Patent number WO0008582 of Feb. 17, 2000, Patent number WO0067426 of Nov. 9, 2000 and WO0068865 of Nov. 16, 2000 introduce ways for parties to resolve simple disputes like those between a customer and a store or other non-judicial disputes. They do not have the ability to handle the complex workflows of employee dispute resolution between multiple parties and their advisors at multiple levels—a requirement of many union dispute resolution procedures. None of these embodiments allow multiple owners to administer their domain and restrict access of the other to sensitive management data. For instance, Union organizations would not entrust their grievance system data to a system owned and administered by Company management.

U.S. Pat. Nos. 784,432, 6,049,591, and 5,895,450 are primarily targeted at handling simple consumer complaints. They cannot be used when a contract specifies a dispute resolution procedure involving several levels of management within an organization. With these inventions complaints have no distinction between a low-level team resolution and an executive level resolution. In most organizations today it desirable to resolve grievances at the lowest level possible where the costs are lowest and the information is well understood. Only after not resolving grievances at the lowest level would a more senior set of Company and Union officials get involved to resolve the grievance. None of the methods in the prior art integrate a method that effectively passes a dispute to the next higher level of management as is commonly done in business. Nor do any methods in the prior art have an integrated timeline management feature that tracks the progress of a dispute versus an agreed upon timeline of actionable steps and initiates reminders, notifications, alarms, and automated consequences of missed actions.

Although some of these methods may be applicable to specific limited types of dispute resolution and may offer a value proposition in terms of speed or cost reduction, none of them can be used to address a typical dispute between an employee and manager in a union environment with heavily structured and elaborate dispute resolution procedures. One knowledgeable in the art can point to other examples where the prior art falls short in addressing established organizational decision trees and reporting relationships, a key value proposition for my invention.

### SUMMARY OF THE INVENTION

The present invention is a unique method for resolving an employee dispute via a network, the method comprising: typing a grievance in a computer readable form; communicating the grievance to a first lower level of management in a union; communicating the grievance with the union's approval to a first lower level of management of a defending company; communicating the grievance to a human resources organization within the company; when the grievance is not resolved by the lower levels of management, repeatedly communicating the grievance to a higher level of management within the organizations until the grievance is resolved; and when the grievance is not resolved within the organizations, communicating the grievance to an outside party for resolution. Substantially all communications are performed via a private computer network, the public Internet, or via wireless networks. The method includes time guideline management, database storage and retrieval and decision support, executive reporting features, and group dispute resolution capabilities.

### OBJECTS AND ADVANTAGES

Accordingly, several objects and advantages of my invention are:

a) to provide a method for resolving employee disputes over a private network, a public network such as the Internet, or a wireless network using computers, laptops, personal digital assistants, wireless access protocol enabled phones, and voice phones;

b) to provide a method for resolving employee disputes in a secure online environment where privacy is preserved and the owners of both sides can administer their own domains including;

c) to provide a method for resolving employee disputes which retains the same level of control over potential outcomes that exists in the manual, paper-based dispute resolution process of today;

d) to provide a method for resolving employee disputes which uses the same people and workflow processes, except for the substantial replacement of paper, phone calls, and meetings with electronic files and communications;

e) to provide a method for resolving employee disputes which allows employees, union representatives, managers, and human resource personnel (the users) to file, manage, and respond to grievances and grievance decisions online;

f) to provide a method for resolving employee disputes that eliminates the duplication of effort in retyping grievance information twice—once within the union and once within the company;

g) to provide a method for resolving employee disputes that reduces the time users spend searching for grievance forms and files and traveling to remote offices or plant locations;

h) to provide a method for resolving employee disputes that accesses current human resources and union data to pre-populate many identifying fields on a grievance form, which reduces the time it takes to complete a form, increases the accuracy of the data, and helps ensure the completeness of the data;

i) to provide a method for resolving employee disputes that educates users on the interpretation of the terms and conditions of a union agreement or workplace rules;

j) to provide a method for resolving employee disputes that allows users to search through similar cases of depersonalized grievance information in order to determine the likelihood of success, estimate a range of outcomes before proceeding or advising an employee or manager;

k) to provide a method for resolving employee disputes that allows users to list, search, recall, view, print and manage all prior and current grievances;

l) to provide a method for resolving employee disputes that allows the users to use old grievances and templates to quickly grieve a repeat or common offense and to quickly respond to a repeat or common grievance;

m) to provide a method for resolving employee disputes that allows users to easily file and respond to group grievances affecting many stakeholders.

n) to provide a method for resolving employee disputes wherein arbitrators, mediators, or employee-management committees gain access to the stored online grievance file and guide the resolution or decide the outcome after a grievance is not resolved at a lower level within the organization

Other objects and advantages are:

a) to provide a method for resolving employee disputes which increases the productivity and morale of the employees, management, human resources and union personnel;

b) to provide a method for resolving employee disputes which allows employees, management, human resources and union personnel to upload evidence documents such as emails, Microsoft Word documents, etc.;

c) to provide a method for resolving employee disputes which increases the satisfaction of the employees, management, human resources and union personnel with regard to the grievance process;

d) to provide a method for resolving employee disputes which decreases the liability to a company and union through the establishment and storage of a complete set of documentation of case actions and employee inaction;

e) to provide a method for resolving employee disputes which makes available customized and standard reports for policy making, negotiations, and decision support;

f) to provide a method for resolving employee disputes which centralizes employee dispute data across a company and union organization with ubiquitous and instant access to the system by anyone with an Internet browser and the associated permissions;

g) to provide a method for resolving employee disputes which makes it easier to identify system abuses, ineffective managers, or rogue union representatives;

h) to provide a method for resolving employee disputes which makes it easier to file, reply, communicate, and manage group grievances affecting many people;

i) to provide a method for resolving employee disputes which facilitates an organizational transformation by automating and unifying common responses;

j) to provide a method for resolving employee disputes wherein resolution of the dispute is acknowledged by all parties;

k) to provide a method for resolving employee disputes wherein plural attempts to resolve the dispute are facilitated at each level of management within the organizations;

l) to provide a method for resolving employee disputes where all stakeholders in a grievance case can monitor the status of the grievance and identify who has the next action and when the deadline is;

m) to provide a method for resolving employee disputes which includes a remedy management capability when applicable to increase compliance;

n) to provide a method for resolving employee disputes which includes a self learning module to train users how to use the system;

o) to provide a method for resolving employee disputes wherein old grievance data is digitized or uploaded to the system to create a critical mass of searchable content;

p) to provide a method for resolving employee disputes wherein the concealing of personal grievance information is facilitated;

q) to provide a method for resolving employee disputes wherein the union contract terms and conditions are available online for quick and easy access.

r) to provide a method for resolving employee disputes wherein dispute resolution costs and cycle times are reduced due to resolving more disputes internally.

Further objects and advantages of my invention will become apparent from a consideration of the drawings and ensuing description.

### DESCRIPTION OF DRAWINGS

The included figures are tailored for a typical company-union environment and workflow. Not all capabilities need to be included for every environment, nor will the procedural steps of the method exactly be those shown below. These are meant as generalized examples. The intent of this patent is to provide protection against deviations from the method portrayed below.

FIG. 1 shows the main technology components of the employee dispute resolution method.

FIG. 2 presents the high level steps in the method for resolving an employee dispute.

FIG. 3 demonstrates the most common features and procedures of the method.

FIG. 4 shows the architecture of the technology solution employed in the method.

FIG. 5, FIG. 6, and FIG. 7 comprise the first level detail steps of the method. FIG. 5 shows the filing of the employee grievance through submission to the union. FIG. 6 shows the reception of the grievance by the union through submission to management. FIG. 7 shows the reception of the grievance by management through the final decision.

A dispute can be resolved during or at the end of the first step so disclosing one complete level should be enough to enable someone knowledgeable in the art to enable an employee dispute resolution method via a network.

### DETAILED DESCRIPTION OF INVENTION

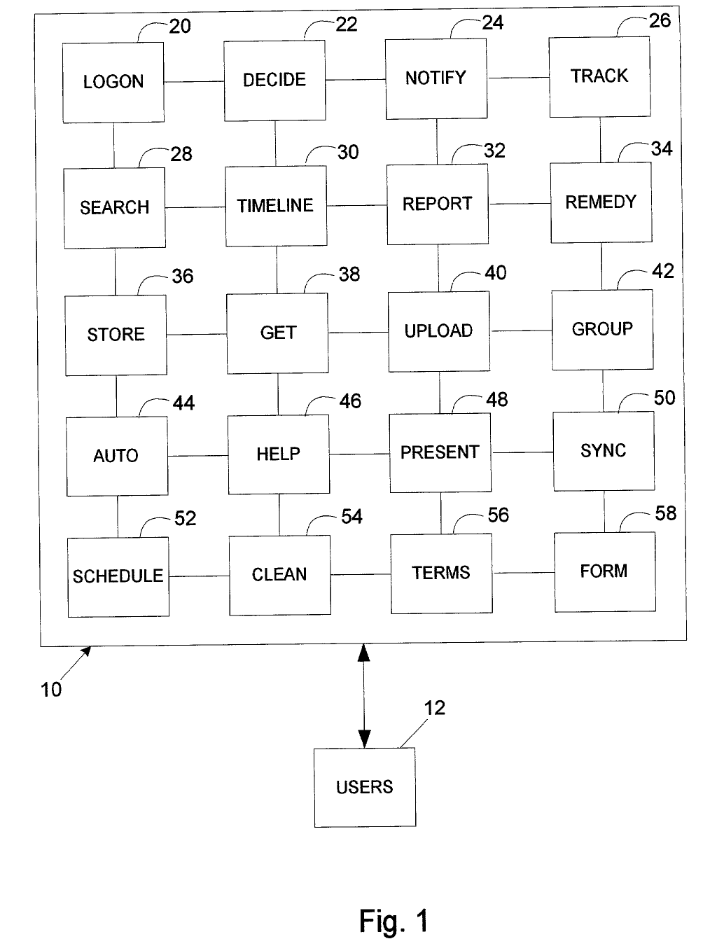

FIG. 1 shows the main technology components of the employee dispute resolution method. The method comprises the use of a technology solution 10 consisting of a set of interconnecting and integrated functions and capabilities that are accessed by a set of users 12.

Logon 20 enables a user to logon from any network based connection whether it be a virtual private network or the preferred embodiment of the Internet, or a wireless network using personal digital assistants or web enabled phones. The logon verifies the user identity through matching of a private password and finds the user in the user table to allocate access privileges and sends the user to his home page.

Decide 22 both helps make decisions by allowing a user to retrieve depersonalized information on similar grievance situations and previous outcomes. An alternative embodiment has automated decision intelligence that is either pre-programmed or learned by the system to respond to repetitive or common disputes.

Notify 24 uses communication software such as Microsoft Exchange in the preferred embodiment to email, page, fax, call, or mail notifications to users regarding new disputes, approaching deadlines, meeting requests, or other action item request.

Track 26 follows the workflow process and increments an index for every completed step in the process. Users can view this information to tell where a grievance is in the system and who is the next person to require an action. Track is also used to watch for management, employee, and union abuses. An alternative embodiment can track the click streams of system users to study user interface design or communication improvements.

Search 28 searches the database tables' fields and records for terms the user entered on a search page. Search results are returned from the database in table format, which can be sorted in various dimensions. Only information which a user has access rights to will be returned. In an alternative embodiment, searching can be performed of other companies or union depersonalized information or other available Internet content.

Timeline 30 can be customized to match the specific contract timeline requirements of each step within the existing employee dispute resolution procedures. The preferred embodiment uses Timeline to create status pages of grievances, which would show disputes that needed immediate action in a red color, disputes needing action soon in a yellow color, and new disputes not requiring action soon in a green color. Timeline passes parameters to Track and to Notify to complete an alarm.

Report 32 allows company managers to create custom or standard reports spanning company departments or plants over which they have access rights. Union personnel can also create reports, which span union plants or departments. In an alternative embodiment the company and union manager can compare internal reports to best in industry performances and summarize regional or race based information, etc.

Remedy 34 helps to increase the compliance of implementing a remedy. Often grievance procedures and relationships start to break down if a grievance is resolved but the remedy is not implemented. Remedy can help keep follow on grievances out of the system, especially when an implementation deadline and action person are established as part of the remedy. This information is entered into the system and Tracked.

Store 36 reads information from a users network communication transmission, usually a web page form submission, and stores it in the proper database table locations via common gateway interface language or Java language.

Get 38 retrieves information from the proper database table locations via common gateway interface language or Java language and build a dynamic web page with the retrieved information as part of the page content.

Upload 40 allows users to upload emails, Microsoft Word documents, Spreadsheets, pictures, digital recordings such as voice mails, and scanned documents.

Group 42 facilitates the group filing of grievances. Employees can assemble other affected employees and submit one grievance for a group. Likewise, a union can file a group or Association grievance for a class of employee. Company management and human resources have equally powerful tools to respond to groups of employee grievances or Association grievances. The intent is to make the resolution process more effective and efficient without granting one side extra power or information that can impact a decision.

Auto 44 learns from repetitive and common grievances and how users respond to such grievances and then categorizes the grievances and prepares a draft response for review. An alternative embodiment resolves grievances automatically using position-based optimization routines or bid matching.

Help 46 provides an integrated help environment for system and method users.

Present 48 identifies the route a user took to access the system in order to present a grievance management homepage with the appropriate logos of the originating system. In the preferred embodiment a user would be presented company logo information if accessing the system from an Internet Protocol (IP) address assigned to a computer terminal at a work location. Conversely, a user accessing the system from a union hall would see union identification information.

Sync 50 synchronizes information between the system database and the human resources database within both the company and the union (if available) to pre-populate the routine part of the grievance forms with correct and complete information.

Schedule 52 allows users to schedule a face-to-face meeting, teleconference, or videoconference. It notifies the invited users and facilitates the selection of a time that fits everyone's schedule by communicating a list of open times and monitoring selections.

Clean 54 depersonalizes grievances so others can view the grievance content. Users are asked to use Clean upon the completion of the grievance process, which guides them through cleaning the data and releasing it to the public.

Terms 56 contains the full text and interpretation notes of the union contracts and/or workplace rules and policies. Agreements can be sorted via Article or paragraph.

Form 58 creates form letters for data requests, requests for arbitration, grievance notifications, etc where US Mail is still part of the only approved dispute resolution process. The preferred embodiment changes the approved or negotiated dispute resolution process to replace US Mail with email.

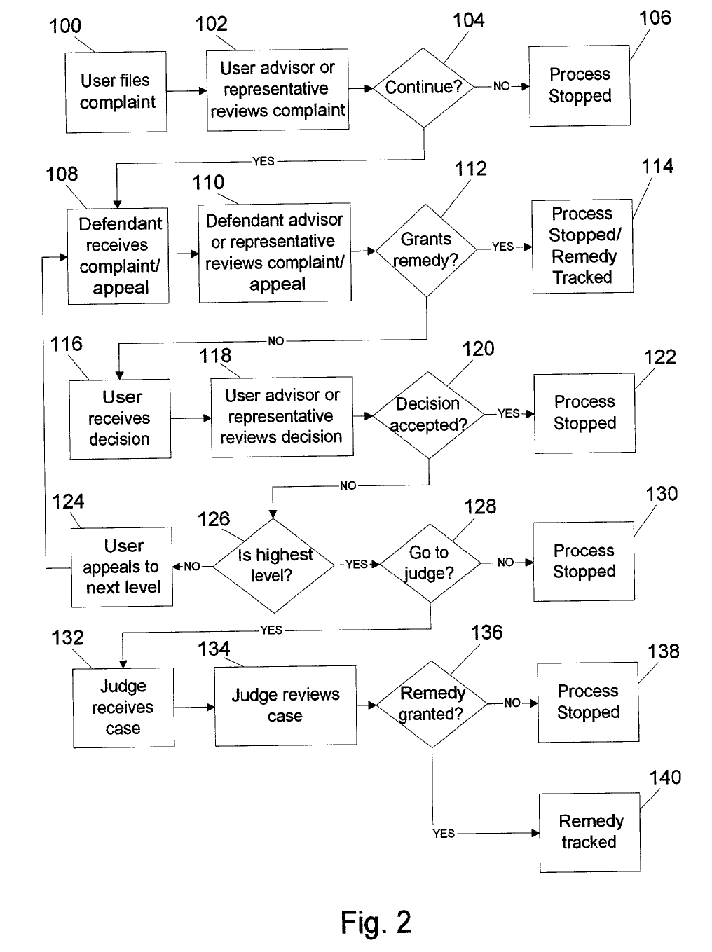

FIG. 2 presents the high level steps in the method for resolving an employee dispute via a network. Starting from the upper left a user logs onto the system and files a complaint or grievance 100. The grievance notification is sent electronically to the employees union or employee representative for review 102. The union representative receives the email, phone, or mail notification and logs onto the system to review grievance. The union rep and employee collaborate to decide 104 whether to pursue the grievance and search the database of old related grievance to improve decision-making. If decision is no, the process is stopped and recorded as an avoided grievance 106. If decision is yes, the union representative digitally signs the approval of the grievance and sends it electronically to the company management or defendant. Defendant receives complaint or appeal 108 and logs onto system to review union approved grievance. Defendant sends notification to human resources office or advisor who logs onto system and reviews the grievance or appeal 110. Defendant and advisor decide whether to reject or grant remedy 112. If granted, the process is stopped, the grievance is stored, and the remedy is tracked 1 14. If not granted, the user receives notification 116 and subsequently logs on to review the company managers decision. User searches available information and possibly sends request for appeal to union electronically. Union receives notification and logs on to review decision 118 and employee request for appeal. Union and User collaborate to decide whether to accept management decision 120. If yes, the process is stopped and recorded 122. If no, and there is a higher level or step of management to appeal to, grievance is appealed to next step 124 and process repeats. Defendant receives complaint/appeal 108 and continues in this manner until there is no higher level within the organizations to appeal, then a determination to go to a judge, arbiter, mediator, or employee-management committee 128 is made. If the decision to judge is no, process is stopped and recorded 130. If yes, request for judge is sent and down selection process is initiated until union and management agree on judge. Judge receives notification 132, logs onto system and reviews case 134. If the remedy is rejected 136, the process is stopped and stored 138. If the remedy is granted the decision is stored and the remedy is tracked 140.

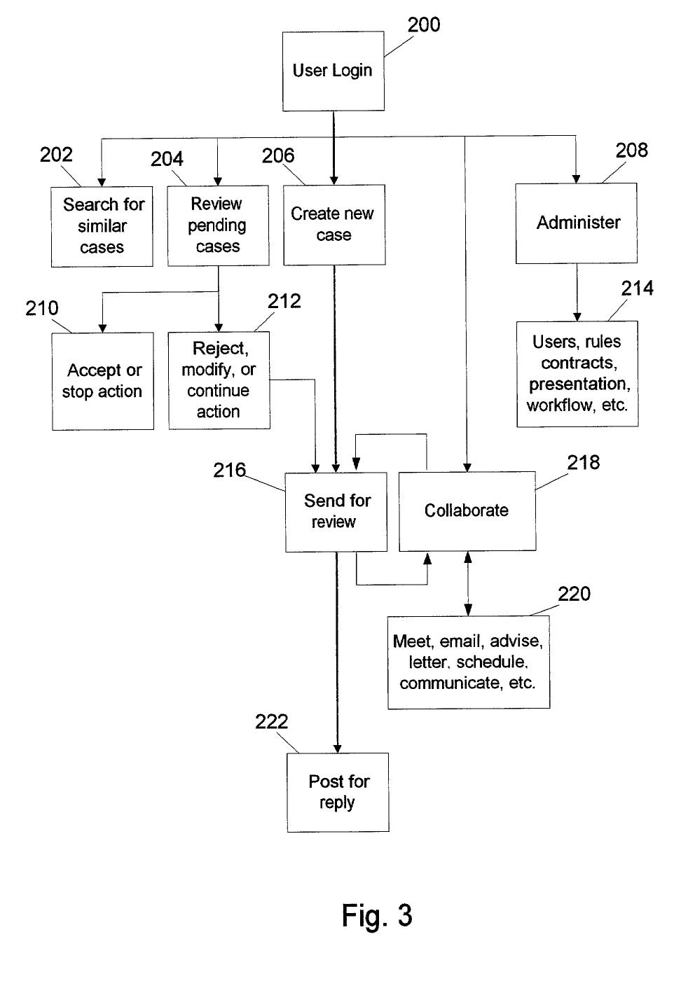

FIG. 3 demonstrates the most common features and procedures of the method. A user first logs into the system 200, whether it be an employee, a union representative, a company manager, a company human resources person, or a judge. The user has available an array of selections to perform tasks including Searching for Similar Cases 202, Review Pending Cases 204, Create a New Case 206, Collaborate 218, or Administer 208. Several tasks will be limited or unavailable to the user based on the user login account privileges: in the preferred embodiment search results will be limited to the user's personal grievances or de-personalized grievances; a manager user would have access to grievances of any employee that grieves against him/her; the top union official would have access and usually decision rights to any union employee's grievance; and only Administers would be able to enter the Administer section. There are too many combinations of login roles and hierarchical positions to delineate between them all here. Someone knowledgeable in the art will be able to make the required extrapolations. If the user selects Review Pending Cases 204 the user can make the decision on any grievance on which the user is tasked to perform the next action. The user can Accept or Stop the action 210 or Reject, Modify, or Continue the action 212. If the user chooses to Continue an action or Create a new case 206, the user will be allowed to send the grievance for review 216 to the union or some other employee representative such as an employee-management committee. When a grievance is sent for review the collaboration features can be used to schedule a meeting, email a grievance stakeholder, advise an employee or manager, communicate, and send letters 220. After collaboration a user, with final authority to forward a grievance to the next level, digitally signs the action using a password or some other approved method of legally establishing identity, and the action is posted for reply 222. If the user entering the system belongs to an administrator group, the user will be able to modify user access rights, grievance process business rules, contractual changes, the look and feel of the presentation to users, and workflow order, etc. 214.

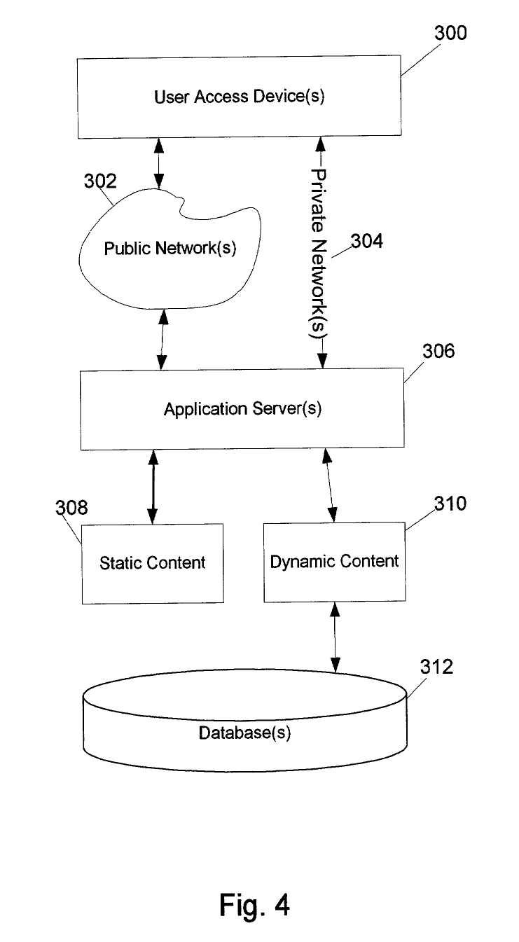

FIG. 4 shows the architecture of the technology solution employed in the method. The operation of the system is controlled by users through user access devices 300, which include computers, laptops, personal digital assistants, web enabled wireless phones, voice phones, etc. The connection from the devices can be made over a public network 302 such as the Internet, or a private network 304 such as America Online, a company Intranet, or a Virtual Private Network. The users send requests via their devices over a network to access an Application Server 306, which listens for requests using a standard protocol such as TCPIP or WAP. The Application Server responds by providing static content files 308, usually displayed via HTML programming and Dynamic Content 310, which is usually generated via CGI, ASP, or JAVA languages. The Dynamic Content sends Structured Query Language requests to a database 312 to retrieve content relative to a user or an action the user has taken. The database supplies the data, which is dynamically written to a HTML file and served via the Application Server over a network to a user access device.

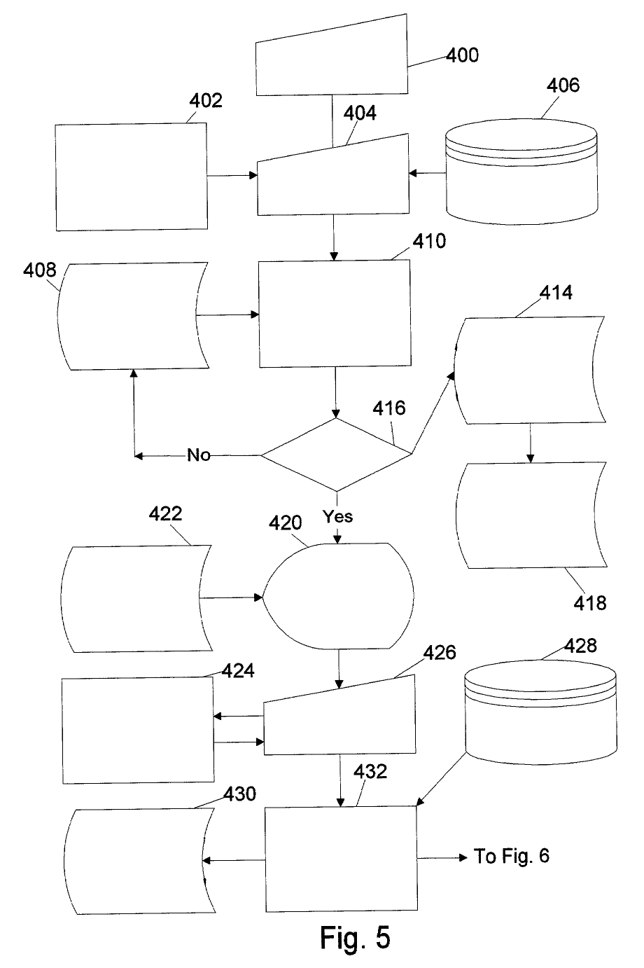

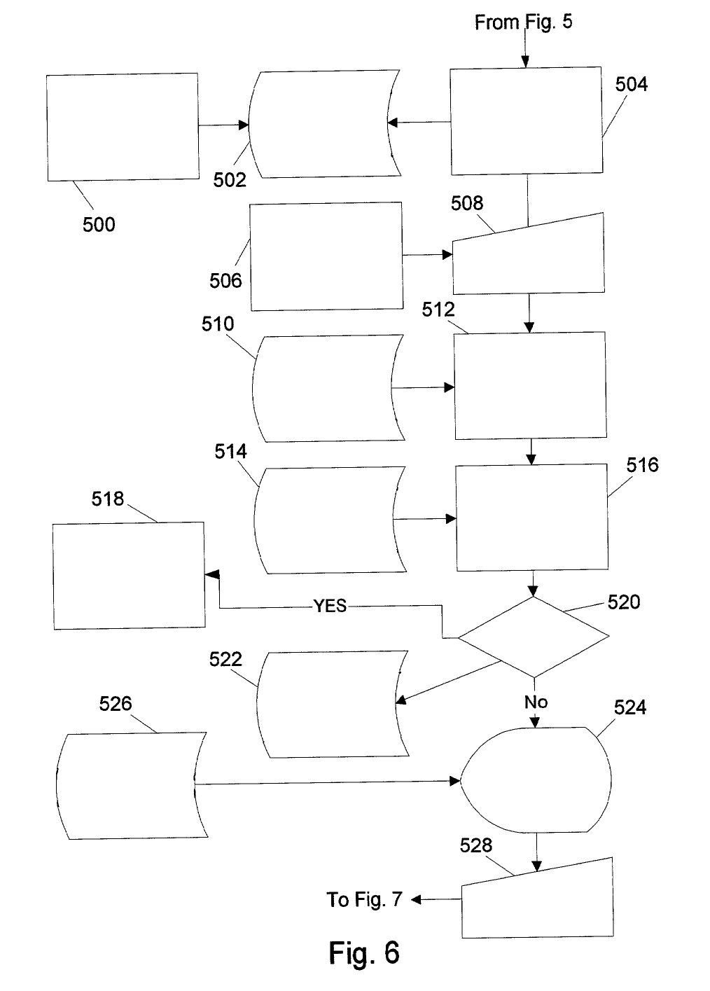

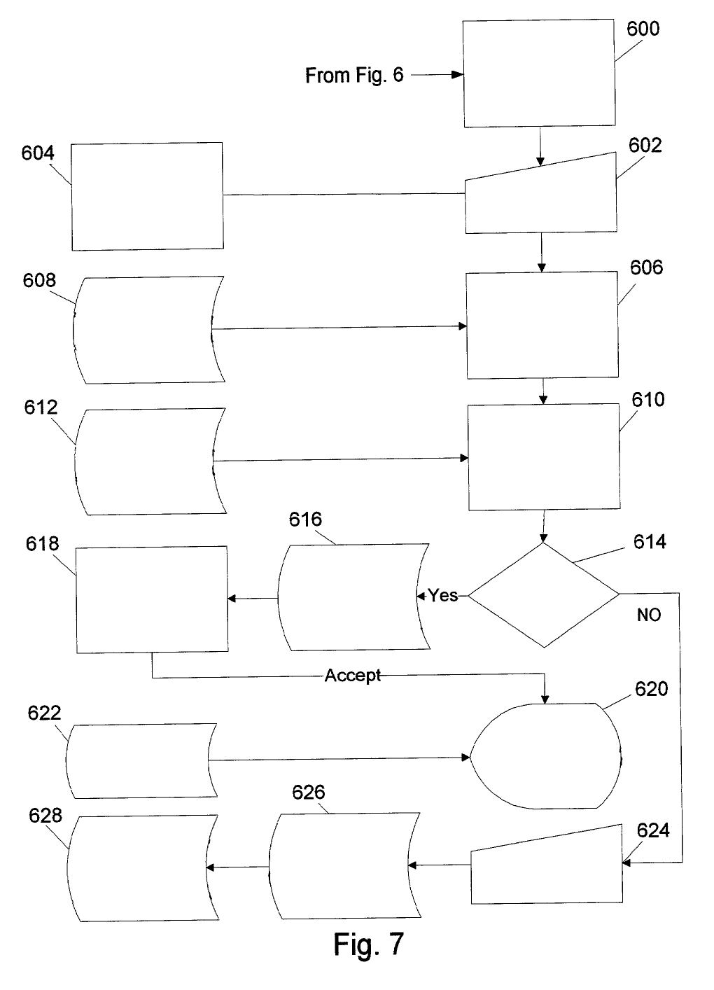

FIG. 5, FIG. 6, and FIG. 7 comprise the first level detail steps of the method, which will provide elaborate detail on how the parts interact, how the method is implemented, and how the system is operated. FIG. 5 shows the filing of the employee grievance through submission to the union. The process is initiated when an employee, an employee group or union steward feels upset and questions whether a grievable offense was committed 400. The user points his/her browser to the company Intranet or union link which will connect his device to the server and proceeds to logon to the server 404. The server performs logon validation, retrieves the employers human resource information from a Human Relations Database 406, checks to make sure if the employee is currently represented by a union, and validates security privileges 402. Once logged in, the user can perform searches for similar grievances with sortable data from local, mid-level and national regions 410. A grievance database including contract articles, typical remedy outcomes and help wizards provide data 408 to the user to support his decision to file a grievance. If the user decides 416 not to file a grievance, the database in updated with the new information and the decision is recorded in a company log 414 and a union log 418. If the user decides to file a grievance 416, a grievance form database 422, provides the proper grievance form with some human resources identifying information already pre-filled in 420. The user completes the form by describing the problem, the alleged articles or rules violated, and an expected remedy 426. A timeline manager starts 424; usually based on the date a violation was alleged. The user attaches or uploads all relevant data, emails, electronic documents, etc. and sends it to the appropriate person identified in the workflow 432. Data is backed up and stored on the remote system database for each user action of a step of a grievance 430.

FIG. 6 shows the reception of the grievance by the union through submission to company management. A union official, steward or employee representative receives notification via email, phone, fax, or mail 504 that a new grievance has entered the system and is waiting for their response or review. The receipt of notification is recorded 502 and the timeline manager tracks the time for this steward action 500. The steward points a browser or other access device to the system via a provided link and enters the steward login information 508. The system validates the login and current status and security 506. If the steward selects a link with the identifying grievance unique identifier, the steward is immediately brought to the action page for the grievance in question. If the steward only enters the login information, the steward is presented with all available grievances and action items, one of which would be the new grievance submitted for his/her review. The steward reviews all relevant documents 512, which may have been attached to the grievance 510. The steward can then perform searches 516 for similar grievances 514 similarly to the employee user, but accessing a wider set of data based upon his/her security privileges. The steward decides 520 whether to request more information from the grieving user or modify the grievance. If the steward requires more information or modifies the grievance a request is sent to the grieving user through the system 518. If the steward is satisfied with the grievance at hand, he/she fills out the related fields on the partially completed grievance form provided from the grievance database 526. In either case the decision of the steward in recorded for the company and union log 522. When the steward portion of the form is completed, the steward digitally signs the form using an approved method of identifying a user to a system and sends 528 the approved grievance to company management.

FIG. 7 shows the reception of the grievance by company management through the final decision. A first level of company management receives notification that a new grievance has entered the system 600. The manager points his browser to the site using specific links comprising unique grievance numbers and logs onto the site with his/her password and account information 602. The system validates the manager login information and checks for current status and security information 604. The manager can then review all grievances, the grievances with open actions for him/her to perform, or the specific new grievance 606 that just entered the system and its attached associated files 608. The manager can perform searches 610 similarly to the grieving user and the union steward, but the results obtained will be related to his/her permission level and hierarchical level within the organization. A grievance database 612 provides similar cases, contract articles, typical remedies, typical outcomes and a help wizard to improve the manager's decision. The manager decides to offer a remedy 614. If the manager offers a remedy the decision is recorded in the union and company logs 616 and the grieving user and union steward both receive notifications that a remedy has been offered, which enables them to login to the system to review the offer and choose to accept or reject it 618. If a remedy is accepted, the employee dispute resolution process is completed and a remedy management application is initiated 620. In all cases the manager completes the relevant online grievance fields, digitally signs the document establishing identity, and decisions are recorded in company and union logs 622. If the manager does not offer a remedy 614, or the grieving user and union steward choose not to accept the remedy offer, a notification of rejection 624 is sent to the company manager and an appeal process 626 is initiated that may include the same level of management in the organizations, but usually involves one higher level of management. The decision to reject and appeal is recorded in company and union logs 628.

It should be evident that the example shown in FIGS. 5 through 7 can easily be modified to include a company human resources advisor, which sometimes assists management and may even assist grieving employees, especially when there is no union present. It should also be apparent that the system can be used for non-union environments by eliminating the union review and approval steps. Depending upon the complexity of the business rules in the organization, there may be as few as one complete resolution step or as many as seven complete resolution steps or iterations through various levels of management and decision-makers. All variations of the employee dispute resolution process can equally be accommodated online by this invention.

Thus the reader will see that the employee dispute resolution method via a network that this invention provides is a highly efficient and effective method for stakeholders in union and non-union represented working environments to file, manage, and resolve employee disputes, especially when there exists multiple levels of decision makers and engrained organizational procedures for routing and handling grievances.

While the foregoing detailed description has disclosed what is presently believed to be the preferred embodiment of the invention, those skilled in the art will appreciate that other and further changes and modifications can be made without departing from the scope or spirit of the invention, and it is intended that all such other changes and modifications are included in and are within the scope of the invention as described in the appended claims.

I claim:

1. A method for resolving a dispute via a network, the method comprising: describing a grievance in a computer readable form; communicating the grievance to a first lower level of management of multiple organizations; when the grievance is not resolved by a lower level of management, repeatedly communicating the grievance to a higher level of management until the grievance is resolved; and when the grievance is not resolved within the organizations, communicating the grievance to an outside party for resolution.

2. The method for resolving a dispute as recited in claim 1, wherein communicating the grievance to a lower level of management, communicating the grievance to each higher level of management, and communicating the grievance to an outside party is performed via a network.

3. The method for resolving a dispute as recited in claim 1, wherein communicating the grievance to a lower level of management, communicating the grievance to each higher level of management, and communicating the grievance to an outside party is performed via the Internet.

4. The method for resolving a dispute as recited in claim 1, wherein describing a grievance in computer readable form comprises typing the grievance and responses into a computer file.

5. The method for resolving a dispute as recited in claim 1, wherein describing a grievance in computer readable form comprises communicating the grievance and responses to a computer.

6. The method for resolving a dispute as recited in claim 1, wherein resolution of the dispute is acknowledged by all parties.

7. The method for resolving a dispute as recited in claim 1, wherein plural attempts to resolve the dispute are facilitated at each level of management within the organizations.

8. The method for resolving a dispute as recited in claim 1, wherein the use of a computer network substantially replaces the conventional, non-network method for resolving the dispute.

9. The method for resolving a dispute as recited in claim 1, wherein describing a grievance in computer readable form comprises digitizing information which describes the dispute.

10. The method for resolving a dispute as recited in claim 1, wherein the process is performed in a substantially paperless fashion.

11. The method for resolving a dispute as recited in claim 1, wherein time guidelines are imposed to facilitate timeline compliance.

12. The method for resolving a dispute as recited in claim 1, wherein remedy tracking is imposed to facilitate compliance.

13. The method for resolving a dispute as recited in claim 1, wherein group processing features are used to facilitate filing and resolution of multiple grievances.

14. The method for resolving a dispute as recited in claim 1, wherein customization of process steps is performed to fit existing organization dispute procedure and management reporting structure.

15. The method for resolving a dispute as recited in claim 1, further comprising using database information to facilitate decision support.

16. The method for resolving a dispute as recited in claim 12, wherein the database information comprises summarized grievance reports.

17. The method for resolving a dispute as recited in claim 12, further comprising assigning administration rights to each party to ensure data protection and privacy.

18. A method for resolving a dispute via the Internet, the method comprising: verbally communicating a grievance to a supervisor; if the supervisor does not resolve the dispute, then describing the grievance in writing to a superintendent; if the superintendent does not resolve the dispute, then describing the dispute in writing to at least one further level of management; if the dispute is not resolved by any level of management, then describing the dispute in writing to an arbitrator/mediator outside of the organization; wherein between one and all steps of describing and resolving the dispute in writing is performed via the Internet.
